(19) United States
(12) Patent Application Publication
(10) Pub. No.: US 2021/0236355 A1
(43) Pub. Date: Aug. 5, 2021

(54) VEHICLE-ROOF-HELD TRACKED LIFTER

(71) Applicant: Dae Sik Kim, Newton, MA (US)

(72) Inventor: Dae Sik Kim, Newton, MA (US)

(21) Appl. No.: 16/778,834

(22) Filed: Jan. 31, 2020

(51) Int. Cl. A61G 3/06; B66F 5/02

(52) U.S. Cl. CPC A61G 3/062; B66F 5/02

(57) ABSTRACT

The presently disclosed Lifter comprises a substantially level horizontal, partially or totally tracked, overhanging bar, which is supported by the roof of a vehicle. The tracked bar is held up against the upper door frames by a ratcheted strap over the roof and in between two open doors on each side of the vehicle. Another ratchet attached to the bar via a trolley is usable for lifting the object, and the trolley allows for its horizontal movement along the tracked bar. Particularly, the object may be an incapacitated person such as a patient. Even more particularly, the patient may be held and restrained in harness-type garment comprising a lifting loop. Generally, the Lifter may be used to lift any heavy object in and out of a vehicle using mechanical leverage. In some embodiments, the bar comprises two shorter C channels removably joined, or a shorter channel with a telescoping extension. Thus, the presently disclosed lifter is very easy to carry, store, and generally handle as an auto accessory.

### BACKGROUND OF THE INVENTION

The present invention is related to a device and method thereof for transferring a person from a car passenger seat to a wheelchair, and vice versa. The present invention is also useful for, and related to, loading or unloading heavy objects from a vehicle with doors on both sides, or a swinging larger rear door, or side door(s) without a ramp. The person may be a person seating in a wheelchair. The object may be an empty, but heavy, wheelchair, or any other heavy cargo.

Ceiling mounted overhead tracked lifters are expensive and limited in capacity. They are widely used in hospitals for hanging movable partitions, moving a moderately heavy equipment to various positions or transferring a patient between the bed and other carriers.

Level overhead tracks provide an easy horizontal movement of heavy suspended objects with a rolling trolley or a lubricated slide. For the purpose of vertical movement of suspended objects, a wide variety of lifting and holding devices have been proposed, developed and currently available.

Currently, many methods and devices are available for moving an incapacitated person, such as a patient. Some require active participation of the patient. Others require more than one caregiver. In particular, specially designed sheets or boards with one pair or more of holding/lifting means are available. Other devices include expensive ground based mobile crane-type lifters, which are not very transportable. Some specially designed and equipped vehicles have retractable ramps or/and swing-arm winches. But, they are very expensive for their limited use, and therefore not affordable for the sizable population in need.

There is an urgent need for a simple and more affordable solution for transporting incapacitated people. Furthermore, it is sometimes safer and definitely more convenient and affordable to carry a patient in a passenger seat of a family car/SUV/Minivan for a hospital visit.

At the present, no simple, affordable, portable and widely adaptable automotive accessory is available for:
1. the common task of transferring a patient between a vehicular seat and a wheelchair.
2. handling the associated heavy objects, including a wheelchair.
3. Loading/unloading a heavy cargo into and from the vans without a ramp.

The present disclosure provides a vehicle-roof-held tracked lifter and methods of use thereof.

### SUMMARY OF THE INVENTION

This invention provides a vehicle-roof-held tracked lifter (also referred to herein as “Lifter”) comprising a substantially level horizontal, partially or totally tracked, overhanging bar which is supported by a roof of a vehicle. The bar is held up against the upper door frames, partially inside the vehicle, by a ratcheted strap positioned over the roof and between two open doors on parallel sides of the vehicle. The tracked bar enables hanging a trolley and sliding it along the tracked bar using methods traditional in the art, thus providing easy horizontal movement. Another ratchet, hanging on the trolley and comprising a strap comprising a lifting hook on its end distal from the ratchet, enables a vertical movement. The Lifter may be used to transfer a patient (“person” and “patient” are used herein interchangeably) held and restrained in any harness/garment comprising an attachment means, for example, a lifting loop. Also, the Lifter may be used to lift many other heavy objects with a mechanical leverage. In some embodiments, the tracked bar is an overhanging partially open C channel, such as a Unistrut, usable for loading/unloading at either, or both side(s), of a vehicle. In some embodiments, the tracked bar comprises two shorter C channels which are removably joined, or a shorter channel with a telescoping extension. This makes the Lifter very easy to carry, store, and generally handle as an auto accessory.

In some embodiments, the present disclosure provides A device for loading and unloading a person, into and from a vehicle, the device comprising:
a. substantially level, overhanging, completely or partially tracked bar comprising a trolley, the bar removably suspend-able across two parallel open doors of the vehicle, wherein when suspended the bar is partially outside the vehicle;
b. means for removably suspending the said bar against the upper door frames of said two parallel open doors;
c. means of moving a person securely held and suspended from the tracked bar vertically; and,
d. means of moving said person horizontally along the said tracked bar.

In some embodiments, the said tracked bar is selected from a group comprising of a single tracked bar, two or more removably joined tracked bars, or a shorter tracked bar with telescoping extension.

In some embodiments, the said bar is a steel C-channel comprising a pair of symmetrical tracking parallel lips.

In some embodiments, the removably suspending said bar comprises the following steps:
a. the tracked bar is positioned partially inside the vehicle, a tie down ratchet is permanently attached to the upper face of said bar on the side used for loading or uploading the person proximal to an end of the tracked bar, and a bracket is permanently attached to the upper face of the bar on the opposite side of the tracked bar proximal to said opposite side end, wherein the tie down ratchet and the bracket are positioned outside the vehicle and proximal to the vehicle's roof;
b. a doubled strap, is positioned over the roof of said vehicle, wherein one end of the strap is secured to the said tie down rachet, while the other end of the strap is connected to the winder of the tie-down ratchet or looped around the tracked bar, and the looped end is attached to the bracket on the opposite side; and, thus, the tracked bar is removably suspended wherein a portion of each of its ends is positioned outside of the vehicle.

In some embodiments, the said means of removably suspending said bar is a pair of mounting studs or tapped bolt holes on said door frames and mating key-hole sluts or bolt holes on said bar and bolts.

In some embodiments, the person is held securely by a harness-type garment comprising an attachment means such as a lifting loop.

In some embodiments, the said means of moving vertically is a ratchet with a doubled strap comprising a lifting hook.

In some embodiments, the said means of moving horizontally is said trolley, wherein the trolley comprises a pair of ball bearings, a short common shaft, a link connecting said shaft and said ratchet.

In some other embodiments, the present disclosure provides a device and method for loading into or unloading a heavy object from a vehicle without a ramp having,
a. a substantially level, overhanging, total or partially tracked bar supported by the roof of said vehicle;
b. a means of mounting said bar on the upper door frames of said door(s) or on the interior roof rib beam of the roof;
c. means of holding said object securely;
d. means of moving said secured object, vertically; and,
e. means of moving said object horizontally along the said track.

### BRIEF DESCRIPTION OF THE DRAWINGS

FIG. 1 is an illustration of a sectional view of a vehicle in which the Lifter is installed. The Lifter's hook is shown attached to a patient harness.

FIG. 2 is an illustration depicting a detailed view of the patient side of the tracked bar comprising the ratchet and hook.

### THE DETAILED DESCRIPTION OF THE INVENTION

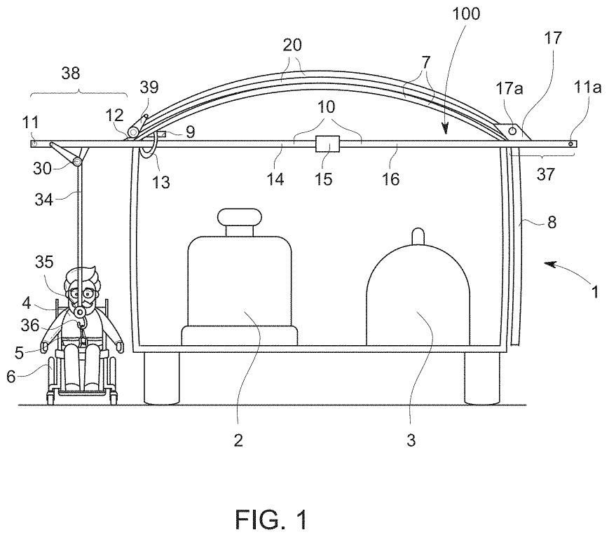

FIG. 1 is a cross-section illustration of a vehicle 1, parked on a level ground, having a split half view of a passenger seat 2 on the left side and a flat cargo bay comprising a cargo 3 on the right side, a Lifter 100 is installed. Depicted is a patient 4 wearing a lifting garment, such as a harness 5, and sitting in a wheelchair 6 positioned next to the passenger side of the vehicle 1.

An over-hanging tracked bar 10 is illustrated partially suspended outside the vehicle. In some embodiments, the tracked bar 10 is about 10′ long, for example the tracked bar 10 can be a Unistrut tracked bar, which is readily available from most building material suppliers. However, the tracked bar 10 may be any suitable C-channel bar or telescoping bar. In some embodiments, the tracked bar 10 comprises about 2′ long portions 37 and 38 which over-hang outside the vehicle 1 at each side and allow operating the Lifter 100 for lifting at either side of the vehicle 1. Retaining screws 11 and 11a keep a trolley 31 attached to the bar 10 from sliding off.

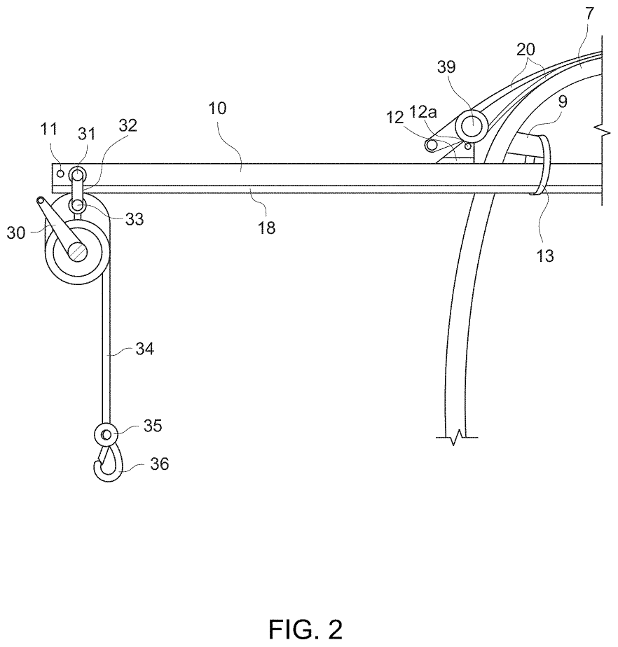

FIG. 2. depicts a holding bracket 12 comprising a holding pin 12a which, in some embodiments, is either welded to or bolted to the top face of the tracked bar 10. An elastic cord 13 can be used to attach the tracked bar 10 to the vehicle's 1 assisting grip 9 while the driver side of over-hanging tracked bar 10 is being secured, for example with holding bracket 17. In some embodiments, the tracked bar 10 is secured to the vehicle 1 using a strap 20 which wraps around the outside of the vehicle's 1 roof 7, width-wise, and attaches to the tracked bar 10 on each side of the roof, thus holding the tracked bar 10 suspended partially inside the vehicle 1, and partially outside the vehicle 1. This attachment may involve brackets 12 and 17, ratchet 39 and strap 20 and is further discussed below. Additionally, on the side not used for lifting, the Lifter 100 may rest on the vehicle's door 8. In some embodiments, to improved portability, the tracked bar 10 may be cut into two shorter pieces 14 and 16. A coupler 15 may be used to join 14 and 16 prior to installation. In some embodiments, piece 16 may be simply replaced with a 1.25″ square tube which telescopes into the, for example, Unistrut tube 14. In some embodiments, the coupler is a 6″ long piece of 1.25″ square tube.

When the Lifter 100 is used to lift a cargo at both sides of a vehicle 1, for example a van-type vehicle, the bracket 17 and pin 17a are required on the driver side of the tracked bar 10. When the lifting is done on only one side, most often the passenger side, a small overhang 37 is needed for a strap 20 to wrap and hold up the tracked bar 10 without the use of 11a, and 17. Finally, the open driver side sliding door 8 is shown.

In FIG. 2, bracket 12 is depicted comprising pin 12a and permanently mounted on the tracked bar 10. Bracket 12 is attached to ratchet 39. Rachet 39 may be releasable attached to a looped end of the strap 20. The strap 20 is looped, or in other words doubly folded, and both ends of the looped strap 20 are releasably attached to bracket 17 positioned at the over-hanging portion of the driver side the tracked bar 10. This arrangement for attaching the Lifter 100 to a vehicle 1 prevents any metal parts of the Lifter 100 from touching and/or scratching the painted surface of the vehicle 1 and doubles the holding/lifting capacity of the Lifter 100. An elastic cord, or loose cord, 13 may be used to releasably attach the tracked bar 10 to an assist grip 9 of a vehicle 1. When an assist grip 9 is not available, a string, or any similar means, for example rope or a strap, comprising two suction cups at each end can easily hold up the tracked bar 10 without damaging the painted surface of the vehicle 1. The ratchet used in the present invention may be any ratchet traditionally used in art. Any ratchet of the presently disclosed Lifter may be, without limitation, tie-down ratchet or any other suitable type of ratchet.

FIG. 2 further depicts a trolley 31 comprising a pair of matched ball bearings riding on the horizontal tracks 18 of the tracked bar 10 and mounted on a short shaft separated by a link 32. The link 32 comprises a stretched segment of 1″ copper (or any other suitable material) tubing and attaches the short shaft and a mounting pin 33 on the second ratchet 30. A folded end of a strap 34 is connected to the pin 33 at the top. The strap 34 is attached to a rolling pin 35 of an attachment means, such as a lifting hook 36, or more than one lifting hook 36. The attachment means may be any suitable attachment means known in the art and used for lifting, in some embodiment the attachment means may be a harness, or a harness-type garment. The ratchet 30 winds the other end of the strap 34 and, when desired, lifts an object hanging from the hook 36 with doubled mechanical leverage. In some embodiments, the straps 20 and 34 used in combination with the presently described Lifter 100 are rated 400 pounds, or around 400 pounds. The lifted weight tends to stretch the over-the-roof strap 20 and, occasionally, re-tightening is needed. The horizontal movement of the suspended object takes very little effort with the trolley 31.

Ideally, if auto makers provide a set of mounting studs or bolt holes in such positions in vehicles 1 as the upper door frames or otherwise the strongest parts of the roof, the over-the-roof strap 20 and the first ratchet 39 would not have been necessary. As most vehicle already have, and need, assist grips 9 attached to the upper door frames, a minor relocation and strengthening of the assist grip mounts could have easily met the installments needs of uploading/unloading devices, such as the Lifter 100.

As an example, for a delivery van with a large door, the middle of a level overhanging tracked bar 10 is mounted near the mid points of the door frame and its inboard end is held by an interior rib beam of the roof. The bar 10 and a lifting ratchet swings in when the door is shut. Much like an after-market hitch for a trailer, a roof-supported Lifter 100 can expand the utility of available vehicles.

It will be obvious that various changes and modifications may be made to the Lifter 100 and the method of use thereof described herein. It is intended by the claims which cover such modifications as would suggest themselves to those skilled in the art.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

I claim:

1. A device for loading and unloading a person, into and from a vehicle, the device comprising:
a. substantially level, overhanging, completely or partially tracked bar comprising a trolley, the bar removably suspend-able across two parallel open doors of the vehicle, wherein when suspended the bar is partially outside the vehicle;
b. means for removably suspending the said bar against the upper door frames of said two parallel open doors;
c. means of moving a person securely held and suspended from the tracked bar vertically; and,
d. means of moving said person horizontally along the said tracked bar.

2. The device of claim 1, wherein said tracked bar is selected from a group comprising of a single tracked bar, two or more removably joined tracked bars, or a shorter tracked bar with telescoping extension.

3. The device of claim 2, wherein said bar is a steel C-channel comprising a pair of symmetrical tracking parallel lips.

4. The device of claim 1, wherein removably suspending said bar comprises the following steps:
a. the tracked bar is positioned partially inside the vehicle, a tie down ratchet is permanently attached to the upper face of said bar on the side used for loading or uploading the person proximal to an end of the tracked bar, and a bracket is permanently attached to the upper face of the bar on the opposite side of the tracked bar proximal to said opposite side end, wherein the tie down ratchet and the bracket are positioned outside the vehicle and proximal to the vehicle's roof;
b. a doubled strap, is positioned over the roof of said vehicle, wherein one end of the strap is secured to the said tie down rachet, while the other end of the strap is connected to the winder of the tie-down ratchet, and the looped end is attached to the bracket on the opposite side; and,
thus, the tracked bar is removably suspended wherein a portion of each of its ends is positioned outside of the vehicle.

5. The device of claim 1, wherein said means of removably suspending said bar is a pair of mounting studs or tapped bolt holes on said door frames and mating key-hole sluts or bolt holes on said bar and bolts.

6. The device of claim 1, wherein the person is held securely by a harness-type garment comprising an attachment means such as a lifting loop. The device of claim 1, wherein said means of moving vertically is a ratchet with a doubled strap comprising a lifting hook.

8. The device of claim 7, wherein said means of moving horizontally is said trolley, wherein the trolley comprises a pair of ball bearings, a short common shaft, a link connecting said shaft and said ratchet.

9. A device and method for loading into or unloading a heavy object from a vehicle without a ramp having,
a. a substantially level, overhanging, total or partially tracked bar supported by the roof of said vehicle;
b. a means of mounting said bar on the upper door frames of said door(s) or on the interior roof rib beam of the roof;
c. means of holding said object securely;
d. means of moving said secured object, vertically; and,
e. means of moving said object horizontally along the said track.
